(19) United States
(12) Patent Application Publication
(10) Pub. No.: US 2012/0025152 A1
(43) Pub. Date: Feb. 2, 2012

(54) CONDUCTIVE SILVER POWDER PREPARATION METHOD

(75) Inventor: CHIH-HAO HUANG, Tu Cheng (TW)

(73) Assignee: Cheng Uei Precision Industry Co., LTD., Tu Cheng City (TW)

(21) Appl. No.: 12/848,165

(22) Filed: Jul. 31, 2010

(51) Int. Cl. H01B 1/02

(52) U.S. Cl. 252/514

(57) ABSTRACT

A conductive silver powder preparation method includes the following steps: forming a silver salt solution by mixing a silver salt with a DI (De-ionized) water; forming a sodium citrate solution by well-mixing a sodium citrate with the DI water; heating the silver salt solution until maintaining the silver salt solution at a constant temperature of no less than 80° C.; forming a brown solution by adding the sodium citrate solution into the heated silver salt solution; cooling the brown solution to the room temperature for precipitating to form a brown powder; and forming a conductive silver powder by freezing and drying the brown powder. This method simplifies the prior chemical method without usages of toxic reducing agent and additional protective agent, and complies with the requirements of environment, step simplification and economy.

### BACKGROUND OF THE INVENTION

1. Field of the Invention

The present invention relates to a conductive particle preparation method, and more particularly, to a conductive silver powder preparation method.

2. Description of the Prior Art

Since the 1990s of the twentieth century, various computerized applications were widely popularized day by day to bring a rapid development of electric product, such as a telecommunication apparatus, an imaging apparatus, a network information apparatus and so on. A new generation appliance integrates with a sounding, a light-emitting and an imaging functions, such as an information appliance and a digital appliance. Its related manufacture fast rises with a high development in the art, accompanying the developments of the other arts in various electronic paste and metallic powders.

Several precious metals, such as Pd, Pt, Au and Ag, position irreplaceable in the electronic industry due to their great conductible and applicable abilities. The silver is one of the several precious metals, which is applied broadly and consumed greatly for the electronic industry, and is usually treated as a basic and key material for fabricating various electrical components or products. Thus, the silver is a conductive particle in common use. In general, to get a particle sized in micron or nanometer, a conductive silver particle preparation method is classified into a physical method or a chemical method.

Meanwhile, the physical method is a top-down fabrication for the material. Commonly, a mechanical ball-milling approach is applied for crushing the bulk into an expected tiny size. When a dry type ball milling is utilized to process the material preparation, it might invoke some problems that a dust explosion occurs after the bulks are thinned, and the size is limited to a micron. When a wet type ball milling is used for processing the material preparation, it needs to decide proper solvents and additives with assistances of filtering and drying methods, and therefore perform a complex operation on expensive processing equipments.

The chemical method is a bottom-up fabrication for the material, in which the atom or molecule is dimensioned into nanometer and micron by a chemical reaction with selection of a proper containing-silver salt type as an initial reactant to provide a silver source. It needs to react with a reducing agent under proper conditions so as to extract the silver material.

However, the prior technology usually treats a high-toxic ammonia or formaldehyde as a reducing agent to react. Such a reducing agent does not only belong to a high-toxic chemical but also belongs to a regulated toxicant, and has to take a high risk in the usage. Besides, to avoid the particles becoming larger since colliding with each other during a reaction process, it usually needs to add a protective agent with a proper amount, such as a polyvinyl pyrrolidone (PVP), into a surface of the silver particle for forming a protective layer thereon during the reaction process. Accordingly, the dimension of the particle would not become larger and is maintained within a certain extent that the particles are dimensioned to a nanometer or micron and well distributed, except for needing an additional purification-by-washing step to eliminate an excess PVP.

### BRIEF SUMMARY OF THE INVENTION

One object of the present invention is to provide a conductive silver powder preparation method, which complies with the requirements of a safe environment, simplified step and economy.

To accomplish the above invention object, the present invention provides a conductive silver powder preparation method, which comprises the following steps of: forming a silver salt solution by mixing a silver salt with a DI (de-ionized) water; forming a sodium citrate solution by well-mixing a sodium citrate with the DI water; heating the silver salt solution until maintaining the silver salt solution at a constant temperature of no less than 80° C.; forming a brown solution by adding the sodium citrate solution into the heated silver salt solution; cooling the brown solution to the room temperature for precipitating to form a brown powder; and forming a conductive silver powder by freezing and drying the brown powder.

As mentioned above, the conductive silver powder preparation method according to the present invention does not need to use an expensive equipment required in the physical method for preparing conductive particles, and simultaneously save the needs of using a toxic reducing agent and additional protective agent in a common chemical method for preparation. Thus, the present invention complies with the requirements of environment, step simplification and economy.

### BRIEF DESCRIPTION OF THE DRAWINGS

The present invention may best be understood through the following description with reference to the accompanying drawings, in which:

FIG. 1 illustrates a flow chart of a conductive silver powder preparation method according to the present invention;

FIG. 2 illustrates a flow chart of a conductive silver powder preparation method of a first embodiment according to the present invention;

FIG. 3 illustrates a flow chart of a conductive silver powder preparation method of a second embodiment according to the present invention;

FIG. 4 illustrates a flow chart of a conductive silver powder preparation method of a first embodiment according to the present invention; and

FIG. 5 illustrates a flow chart of a conductive silver powder preparation method of a fourth embodiment according to the present invention.

### DETAILED DESCRIPTION OF THE INVENTION

The advantages and novel features of the invention will become more apparent from the following detailed description of a preferred embodiment when taken in conjunction with the accompanying drawings.

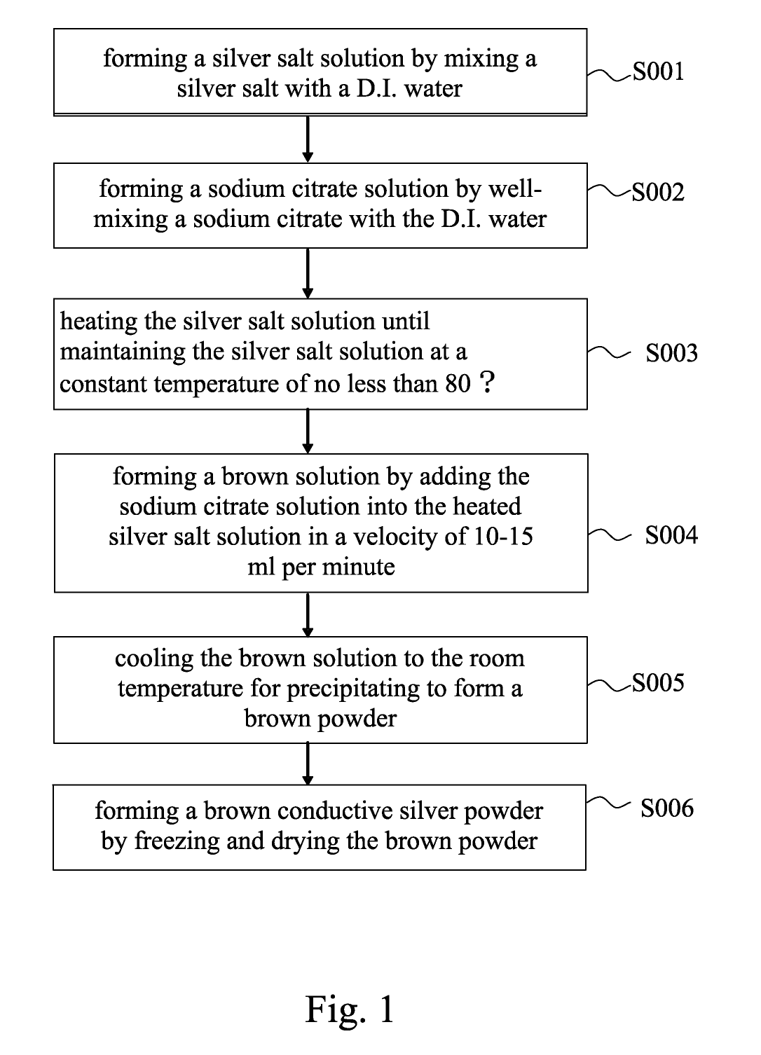

Firstly referring to illustration of FIG. 1, a conductive silver powder preparation method according to the present invention comprises the following steps of:

S001, forming a silver salt solution by mixing a silver salt with DI water;

S002, forming a sodium citrate solution by well-mixing a sodium citrate with the DI water;

S003, heating the silver salt solution until maintaining the silver salt solution at a constant temperature of no less than 80° C.;

S004, forming a brown solution by adding the sodium citrate solution into the heated silver salt solution in a velocity of 10-15 ml per minute;

S005, cooling the brown solution to the room temperature for precipitating to form a brown powder; and

S006, forming a brown conductive silver powder by freezing and drying the brown powder.

The next descriptions are to implement a conductive silver powder preparation method by the four embodiments according to the present invention.

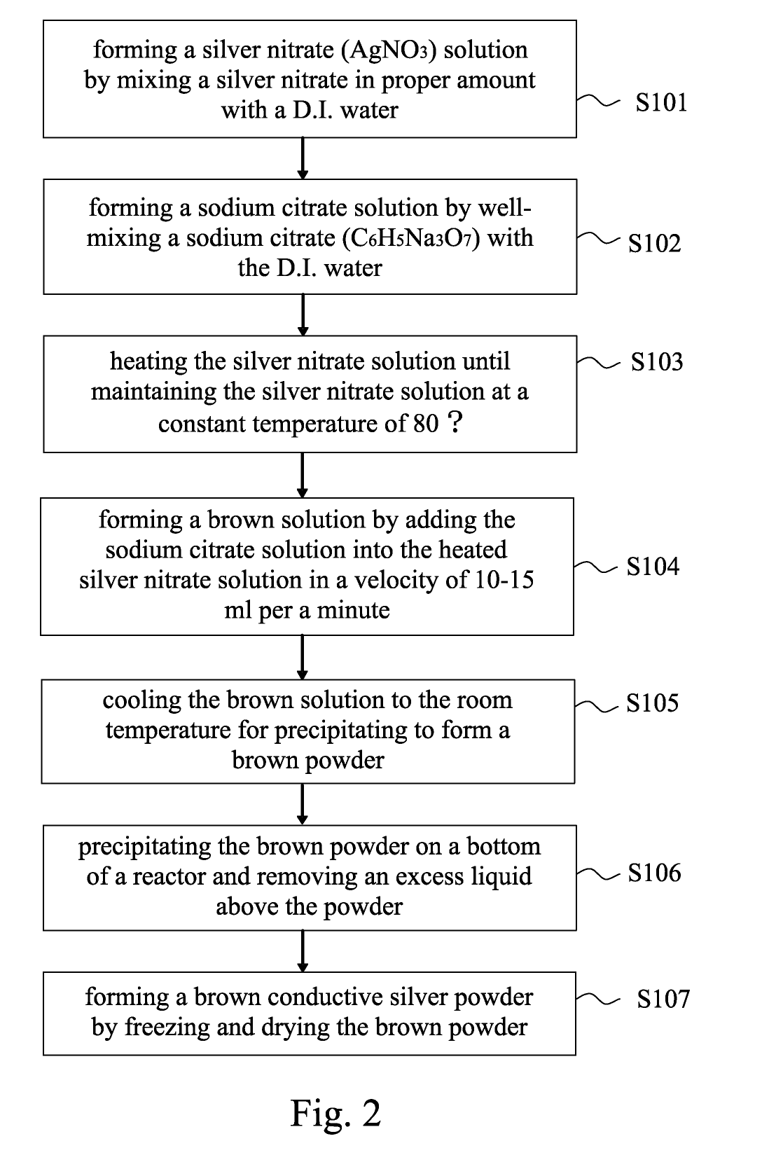

Please refer to FIG. 2, which illustrates a flow chart of a conductive silver powder preparation method of a first embodiment according to the present invention, and comprises the following steps of:

S101, forming a silver nitrate (AgNO₃) solution by mixing a silver nitrate in proper amount with DI water;

S102, forming a sodium citrate solution by well-mixing a sodium citrate (C₆H₅Na₃O₇) with the DI water;

S103, heating the silver nitrate solution until maintaining the silver nitrate solution at a constant temperature of 80° C.;

S104, forming a brown solution by adding the sodium citrate solution into the heated silver nitrate solution in a velocity of 10-15 ml per a minute;

S105, cooling the brown solution to the room temperature for precipitating to form a brown powder;

S106, precipitating the brown powder on a bottom of a reactor and removing an excess liquid above the powder; and

S107, forming a brown conductive silver powder by freezing and drying the brown powder.

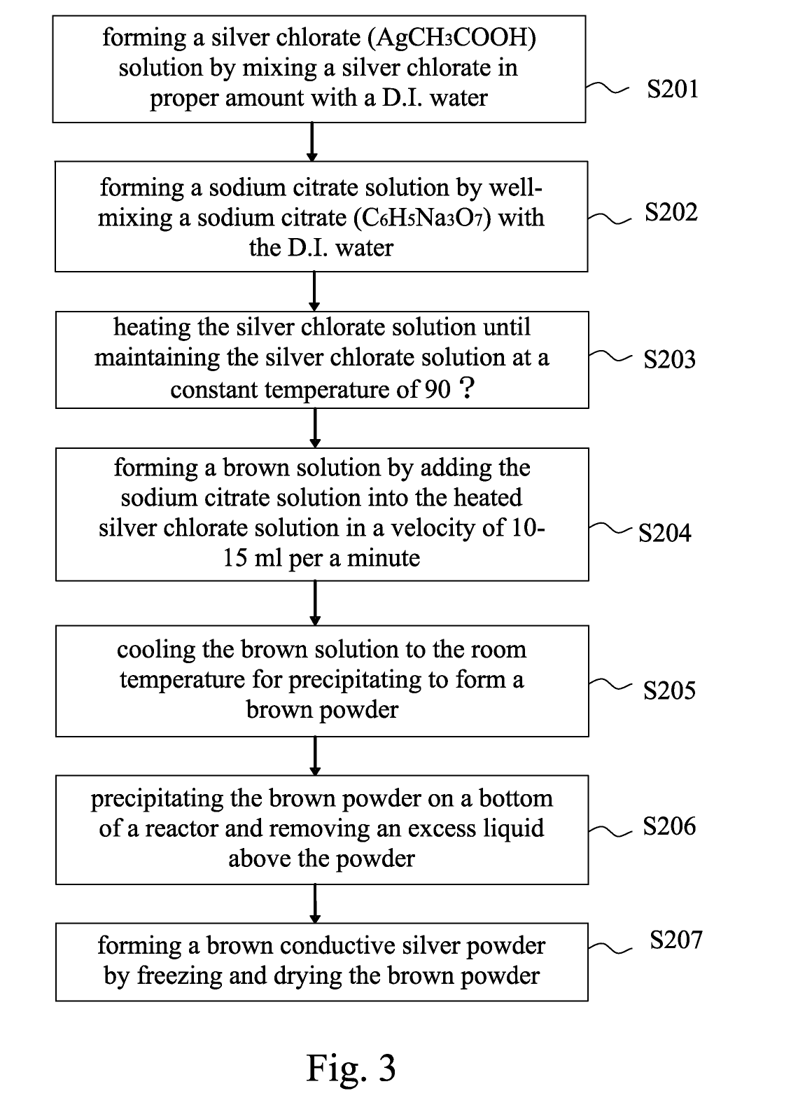

Please refer to FIG. 3, which illustrates a flow chart of a conductive silver powder preparation method of a second embodiment according to the present invention, and comprises the following steps of:

S201, forming a silver chlorate (AgCH₃COOH) solution by mixing a silver chlorate in proper amount with DI water;

S202, forming a sodium citrate solution by well-mixing a sodium citrate (C₆H₅Na₃O₇) with the DI water;

S203, heating the silver chlorate solution until maintaining the silver chlorate solution at a constant temperature of 90° C.;

S204, forming a brown solution by adding the sodium citrate solution into the heated silver chlorate solution in a velocity of 10-15 ml per a minute;

S205, cooling the brown solution to the room temperature for precipitating to form a brown powder;

S206, precipitating the brown powder on a bottom of a reactor and removing an excess liquid above the powder; and

S207, forming a brown conductive silver powder by freezing and drying the brown powder.

In the aforementioned first and second embodiments, by a scanning electron microscope, it is observed that the formed conductive silver powder has a particle size measured at between 150-250 nm. The conductive silver powder with 12.5 wt % of an additive content is dispersed well in (H₂O/polyvinyl alcohol=9:1 wt %) the solvent. Then, the solvent is coated on a PU substrate by a dip-coating approach to form a film. After the film is heated under a temperature of 150° C. for 10 minutes, an averaged resistivity of 5.2 (Ω·cm) is achieved by a micro-ohmmeter measuring the resistances of the film. Besides, in the aforementioned first and second embodiments, an averaged resistivity of 5.2 (Ω·cm) is achieved by the micro-ohmmeter measuring the resistances of either the silver nitrate solution or the silver chlorate solution which is maintained at a constant temperature of 85° C.

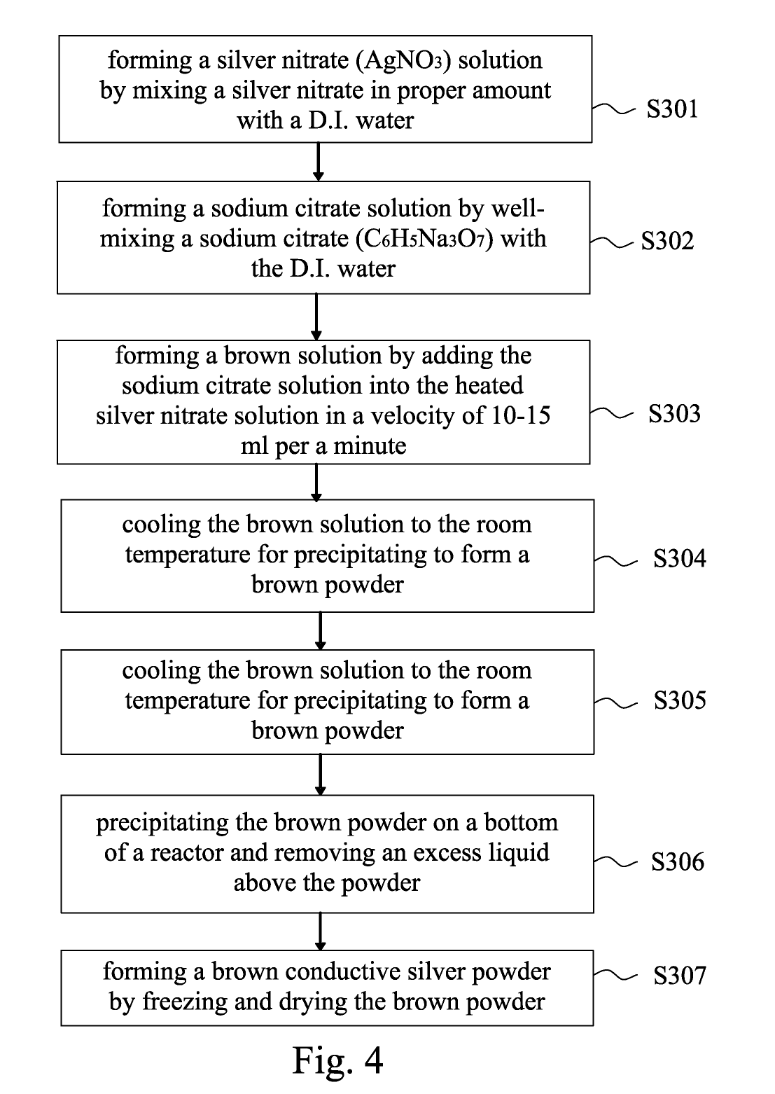

Please refer to FIG. 4, which illustrates a flow chart of a conductive silver powder preparation method of a third embodiment according to the present invention, and comprises the following steps of:

S301, forming a silver nitrate (AgNO₃) solution by mixing a silver nitrate in proper amount with DI water;

S302, forming a sodium citrate solution by well-mixing a sodium citrate (C₆H₅Na₃O₇) with the DI water;

S303, heating the silver nitrate solution until maintaining the silver nitrate solution at a constant temperature of 120° C.;

S304, forming a brown solution by adding the sodium citrate solution into the heated silver nitrate solution in a velocity of 10-15 ml per a minute;

S305, cooling the brown solution to the room temperature for precipitating to form a brown powder;

S306, precipitating the brown powder on a bottom of a reactor and removing an excess liquid above the powder; and

S307, forming a brown conductive silver powder by freezing and drying the brown powder.

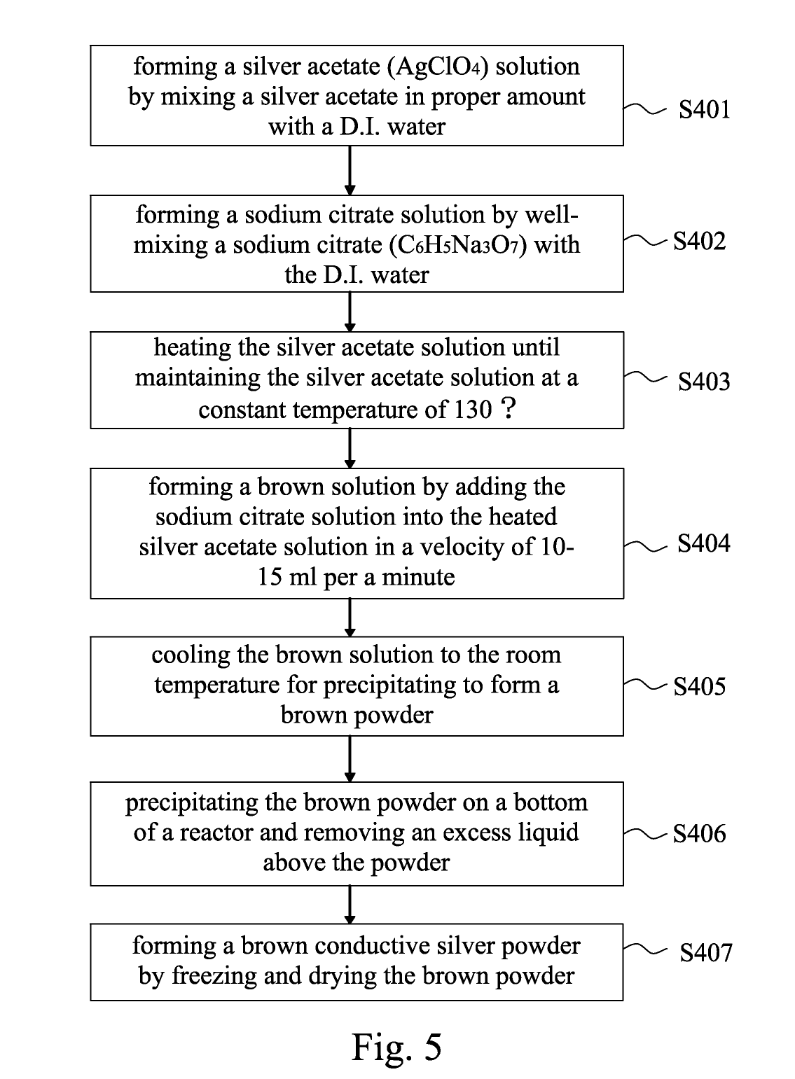

Please refer to FIG. 5, which illustrates a flow chart of a conductive silver powder preparation method of a fourth embodiment according to the present invention, and comprises the following steps of:

S401, forming a silver acetate (AgClO₄) solution by mixing a silver acetate in proper amount with DI water;

S402, forming a sodium citrate solution by well-mixing a sodium citrate (C₆H₅Na₃O₇) with the DI water;

S403, heating the silver acetate solution until maintaining the silver acetate solution at a constant temperature of 130° C.;

S404, forming a brown solution by adding the sodium citrate solution into the heated silver acetate solution in a velocity of 10-15 ml per a minute;

S405, cooling the brown solution to the room temperature for precipitating to form a brown powder;

S406, precipitating the brown powder on a bottom of a reactor and removing an excess liquid above the powder; and

S407, forming a brown conductive silver powder by freezing and drying the brown powder.

In the aforementioned third and fourth embodiments, by a scanning electron microscope, it is observed that the formed conductive silver powder has a particle size measured at between 300-500 nm. The conductive silver powder with 12.5 wt % of an additive content is dispersed well in (H₂O/polyvinyl alcohol=9:1 wt %) the solvent. Then, the solvent is coated on a PU substrate by a dip-coating approach to form a film. After the film is heated under a temperature of 150° C. for 10 minutes, an averaged resistivity of 11.5 (Ω·cm) is achieved by a micro-ohmmeter measuring the resistances of the film. Besides, in the aforementioned third and fourth embodiments, an averaged resistivity of 11.5 (Ω·cm) is also achieved by the micro-ohmmeter measuring the resistances of either the silver nitrate solution or the silver acetate solution which is maintained at a constant temperature of 125° C.

In conclusion, the conductive silver powder preparation method according to the present invention does not need to use an expensive equipment required in the physical method for preparing conductive particles, and simultaneously save the needs of using a toxic reducing agent and additional protective agent in a common chemical method for preparation. Thus, the present invention complies with the requirements of environment, step simplification and economy.

Since implementation of some apparatus related to the method according to the present invention is known for a person skilled in the art, it will not be detailed herein.

It is to be understood, however, that even though numerous characteristics and advantages of the present invention have been set fourth in the foregoing description, together with details of the structure and function of the invention, the disclosure is illustrative only, and changes may be made in detail within the principles of the invention to the full extent indicated by the broad general meaning of the terms in which the appended claims are expressed.

What is claimed is:

1. A conductive silver powder preparation method comprises the following steps of:
forming a silver salt solution by mixing a silver salt with DI (de-ionized) water;
forming a sodium citrate solution by well-mixing a sodium citrate with the DI water;
heating the silver salt solution until maintaining the silver salt solution at a constant temperature of no less than 80° C.;
forming a brown solution by adding the sodium citrate solution into the heated silver salt solution;
cooling the brown solution to the room temperature for precipitating to form a brown powder; and
forming a conductive silver powder by freezing and drying the brown powder.

2. The conductive silver powder preparation method as described in claim 1, wherein the step of heating the silver salt solution further comprises a step of maintaining the silver salt solution at a constant temperature between 80° C. and 90° C.

3. The conductive silver powder preparation method as described in claim 1, wherein the step of heating the silver salt solution further comprises a step of maintaining the silver salt solution at a constant temperature between 120° C. and 130° C.

4. The conductive silver powder preparation method as described in claim 1, further comprising a step of precipitating the brown powder on a bottom of a reactor and removing an excess liquid above the brown powder after the step of forming the brown powder.

5. The conductive silver powder preparation method as described in claim 1, further comprising a step of adding the sodium citrate solution into the heated silver acetate solution in a velocity of from 10 to 15 ml per a minute.

6. The conductive silver powder preparation method as described in claim 1, wherein the silver salt is one of silver nitrate, silver chlorate and silver acetate.

7. The conductive silver powder preparation method as described in claim 2, wherein the silver salt is one of silver nitrate, silver chlorate and silver acetate.

8. The conductive silver powder preparation method as described in claim 3, wherein the silver salt is one of silver nitrate, silver chlorate and silver acetate.

9. The conductive silver powder preparation method as described in claim 4, wherein the silver salt is one of silver nitrate, silver chlorate and silver acetate.

10. The conductive silver powder preparation method as described in claim 5, wherein the silver salt is one of silver nitrate, silver chlorate and silver acetate.
